(19) United States
(12) Patent Application Publication
(10) Pub. No.: US 2015/0260136 A1
(43) Pub. Date: Sep. 17, 2015

(54) METHOD OF OPERATING A FUEL INJECTOR

(71) Applicant: GM GLOBAL TECHNOLOGY OPERATIONS LLC, Detroit, MI (US)

(72) Inventors: Massimiliano MELIS, Rivoli (IT); Francesco PESCE, Torino (IT); Lucio POSTRIOTI, Perugia (IT)

(73) Assignee: GM GLOBAL TECHNOLOGY OPERATIONS LLC, Detroit, MI (US)

(21) Appl. No.: 14/658,730

(22) Filed: Mar. 16, 2015

(30) Foreign Application Priority Data
Mar. 17, 2014 (GB) 1404788.0

(51) Int. Cl. F02M 51/06; F02D 41/30

(52) U.S. Cl. CPC F02M 51/061; F02D 41/3005

(57) ABSTRACT

A method and system for operating a fuel injector of an internal combustion engine is disclosed in which the fuel injector is driven by an energizing current profile for an energizing time interval. An energizing current profile is selected for each fuel injection in a fuel injection system from among a plurality of predetermined energizing current profiles based on a function of an engine combustion mode. For each selected energizing current profile, a corresponding energizing time is determined as a function of a common rail pressure value and a fuel quantity value.

### CROSS-REFERENCE TO RELATED APPLICATION

This application claims priority to Great Britain Patent Application No. 1404788.0, filed Mar. 17, 2014, which is incorporated herein by reference in its entirety.

### TECHNICAL FIELD

This application pertains to a method of operating a fuel injector of an internal combustion engine, in particular a fuel injector of a common rail system (CRS) utilized for Diesel engines.

### BACKGROUND

It is known that modern engines are provided with a fuel injection system for directly injecting the fuel into the cylinders of the engine. The fuel injection system generally includes a fuel common rail and a plurality of electrically controlled fuel injectors, which are individually located in a respective cylinder of the engine and which are hydraulically connected to the fuel rail through dedicated injection lines.

Each fuel injector, particularly injectors of a common rail system, generally includes an injector housing, a nozzle and a movable needle which repeatedly opens and closes this nozzle. The fuel coming from the rail and passing through the injection pipe and inside the injector housing in a delivery channel, reaches the nozzle and can thus be injected into the cylinder giving rise to single or multi-injection patterns at each engine cycle.

The needle is moved with the aid of a dedicated actuator, typically a solenoid actuator, which is controlled by an electronic control unit (ECU). The ECU operates each fuel injection by generating an electric opening command, causing the actuator to open the fuel injector nozzle for a predetermined amount of time, and a subsequent electric closing command, causing the actuator to close the fuel injector nozzle.

The time between the electric opening command and the electric closing command is generally referred as energizing time of the fuel injector, and it is determined by the ECU as a function of a desired quantity of fuel to be injected.

Currently, the ECU drives solenoid injectors with only one standard current profile, fixed for all electrical pulses and not programmable during engine running. For this reason, solenoid injectors are clearly limited in the possibility to modulate the injection and consequently the rate of heat release from the combustion. This limits implementation of many injection strategies that could have as target the improvement of combustion efficiency, a better warm-up, a decreasing of oil dilution or a better management of the aftertreatment devices. Therefore a need exists for a method of operating a fuel injector which does not suffer of the above inconvenience.

### SUMMARY

The present disclosure provides a method and apparatus of operating a fuel injector of an internal combustion engine, which can be optimized according to the several engine operating conditions.

An embodiment of the disclosure provides a method of operating a fuel injector of an internal combustion engine, wherein the fuel injector is driven by an energizing current profile for an energizing time interval. An energizing current profile is selected for each fuel injection in a fuel injection system from among a plurality of predetermined energizing current profiles based on a function of an engine combustion mode. For each selected energizing current profile, a corresponding energizing time is determined as a function of a common rail pressure value and a fuel quantity value.

An embodiment of the present disclosure also provides an apparatus for performing a method of operating a fuel injector of an internal combustion engine. The apparatus includes an engine control unit configured to select an energizing current profile for each fuel injection in a fuel injection system from a plurality of predetermined energizing current profiles based on a function of an engine combustion mode, and to determine a corresponding energizing time for each selected energizing current profile as a function of a common rail pressure value and a fuel quantity value.

An advantage of this embodiment is that the method allows a solenoid injector to be driven by more than one energizing current profiles. In this way, both injector needle lift profile and injection flow rate can be modulated to match optimal injection requirements. Such requirements include a fast injector needle opening, then a low injection rate in the first phase, followed by a strong increase of the injection rate, until the maximum injection rate is reached and finally, a fast injection rate decrease at the end of injection and a high needle closing velocity.

According to a further embodiment, the selected energizing current profile for a pilot injection or a boot injection has a peak current value not equal to a peak current value of the selected energizing current profile for a main injection. The engine control unit may be configured to operate the fuel injection system with the selected energizing current profile for a pilot injection or a boot injection having a peak current value not equal to a peak current value of the selected energizing current profile for a main injection.

During a warm up phase a split of main injection in two pulses is convenient for an optimal combustion. An advantage of this embodiment is that, using a different current profile between pilot injection or boot injection and main injection (e.g. different peak current) would allow the shaping of the injection flow rate to become more similar to an optimal behavior.

According to another aspect of this embodiment, the selected energizing current profile for a pilot injection or a boot injection has a bypass current value not equal to a bypass current value of the selected energizing current profile for a main injection. The engine control unit may be configured to operate the fuel injection system with the selected energizing current profile for a pilot injection or a boot injection having a bypass current value not equal to a bypass current value of the selected energizing current profile for a main injection. An advantage of this aspect is that using a different current profile between pilot injection or boot injection and main injection, in term of different bypass current, gives flexibility in obtaining an optimal shaping of the injection flow rate.

According to another aspect, the selected energizing current profile for a pilot injection or a boot injection has a hold current value not equal to a hold current value of the selected energizing current profile for a main injection. The engine control unit may be configured to operate the fuel injection system with the selected energizing current profile for a pilot injection or a boot injection having a hold current value not equal to a hold current value of the selected energizing current profile for a main injection. An advantage of this aspect is that using a different current profile between pilot injection or boot injection and main injection, in term of different hold current, gives flexibility in obtaining an optimal shaping of the injection flow rate.

According to a further aspect, the selected energizing current profile for a pilot injection or a boot injection has a time interval of the peak current not equal to a time interval of the peak current of the selected energizing current profile for a main injection. The engine control unit may be configured to operate the fuel injection system with the selected energizing current profile for a pilot injection or a boot injection having a time interval of the peak current not equal to a time interval of the peak current of the selected energizing current profile for a main injection. An advantage of this aspect is that using a different current profile between pilot injection or boot injection and main injection, in term of different time interval of the peak current, gives flexibility in obtaining an optimal shaping of the injection flow rate.

According to a still further aspect, the selected energizing current profile for a pilot injection or a boot injection has a time interval of the bypass current not equal to a time interval of the bypass current of the selected energizing current profile for a main injection. The engine control unit may be configured to operate the fuel injection system with the selected energizing current profile for a pilot injection or a boot injection having a time interval of the bypass current not equal to a time interval of the bypass current of the selected energizing current profile for a main injection. An advantage of this aspect is that using a different current profile between pilot injection or boot injection and main injection, in term of different time interval of the bypass current, gives flexibility in obtaining an optimal shaping of the injection flow rate.

According to still another embodiment, the selected energizing current profile for an after injection or a post injection has a peak current value not equal to a peak current value of the selected energizing current profile for a main injection. The engine control unit may be configured to operate the fuel injection system with the selected energizing current profile for an after injection or a post injection having a peak current value not equal to a peak current value of the selected energizing current profile for a sequence of after injections. Thus, during a regeneration process of an aftertreatment device, a train of after injections or post injections is performed, to warm up the exhaust line. An advantage of this embodiment is that, using a different current profile between after injection or post injection and main injection (e.g. different peak current) allows reducing fuel flow rate and consequently oil dilution.

According to a different aspect of this embodiment, selected energizing current profile for an after injection or a post injection has a bypass current value not equal to a bypass current value of the selected energizing current profile for a main injection. The engine control unit may be configured to operate the fuel injection system with the selected energizing current profile for an after injection or a post injection having a bypass current value not equal to a bypass current value of the selected energizing current profile for a sequence of after injections. An advantage of this aspect is that using a different current profile between after injection or post injection and main injection, in term of different bypass current, gives flexibility in reducing filet flow rate and consequently oil dilution.

According to another aspect, the selected energizing current profile for an after injection or a post injection has a hold current value not equal to a hold current value of the selected energizing current profile for a main injection. The engine control unit may be configured to operate the fuel injection system with the selected energizing current profile for an after injection or a post injection having a hold current value not equal to a hold current value of the selected energizing current profile tier a sequence of after injections. An advantage of this aspect is that using a different current profile between after injection or post injection and main injection, in term n of different hold current, gives flexibility in reducing fuel flow rate and consequently oil dilution.

According to a further aspect, the selected energizing current profile for an after injection or a post injection has a time interval of the peak current not equal to a time interval of the peak current of the selected energizing current profile for a main injection.

The engine control unit may be configured to operate the fuel injection system with the selected energizing current profile for an after injection or a post injection having a time interval of the peak current not equal to a time interval of the peak current of the selected energizing current profile for a sequence of after injections. An advantage of this aspect is that using a different current profile between after injection or post injection and main injection, in term of different time interval of the peak current, gives flexibility in reducing fuel flow rate and consequently oil dilution.

According to a still further aspect, the selected energizing current profile for an after injection or a post injection has a time interval of the bypass current not equal to a time interval of the bypass current of the selected energizing current profile fir a main injection. The engine control unit may be configured to operate the fuel injection system with the selected energizing current profile for an after injection or a post injection having a time interval of the bypass current not equal to a time interval of the bypass current of the selected energizing current profile for a sequence of after injections. An advantage of this aspect is that using a different current profile between after injection or post injection and main injection, in term n of different time interval of the bypass current, gives flexibility in reducing fuel flow rate and consequently oil dilution.

Another embodiment of the disclosure provides an internal combustion engine including a fuel injector, wherein the fuel injector is controlled by a method according to any of the previous embodiments. The method according to one of its aspects can be carried out with the help of a computer program including a program-code for carrying out all the steps of the method described above, and in the form of computer program product including the computer program. The computer program product can be embedded in a control apparatus tier an internal combustion engine, including an Electronic Control Unit (ECU), a data carrier associated to the ECU, and the computer program stored in a data carrier, so that the control apparatus defines the embodiments described in the same way as the method. In this case, when the control apparatus executes the computer program all the steps of the method described above are carried out.

### BRIEF DESCRIPTION OF THE DRAWINGS

The present disclosure will hereinafter be described in conjunction with the following drawing figures, wherein like numerals denote like elements.

FIG. 1 shows an automotive system;

FIG. 2 is a portion of an internal combustion engine shown in the automotive system of FIG. 1;

FIG. 3 schematically shows a standard energizing electrical current profile;

FIG. 4 shows a scheme of a fuel injection sequence;

FIG. 5 shows a profile of an optimal injection rate shaping;

FIG. 6A shows a split main injection, realized with standard current profiles;

FIG. 6B shows a split main injection, realized with variable current profiles;

FIG. 7A shows an after injection, realized with standard current profiles;

FIG. 7B shows an after injection, realized with variable current profiles;

FIG. 8 is a block scheme of the method of operating a fuel injector according to an embodiment of the present disclosure; and

FIG. 9 is a flowchart of the method of operating a fuel injector according to an embodiment of the present disclosure,

### DETAILED DESCRIPTION OF THE DRAWINGS

The following detailed description is merely exemplary in nature and is not intended to limit the present disclosure or the application and uses of the present disclosure. Furthermore, there is no intention to be bound by any theory presented in the preceding background of the present disclosure or the following detailed description.

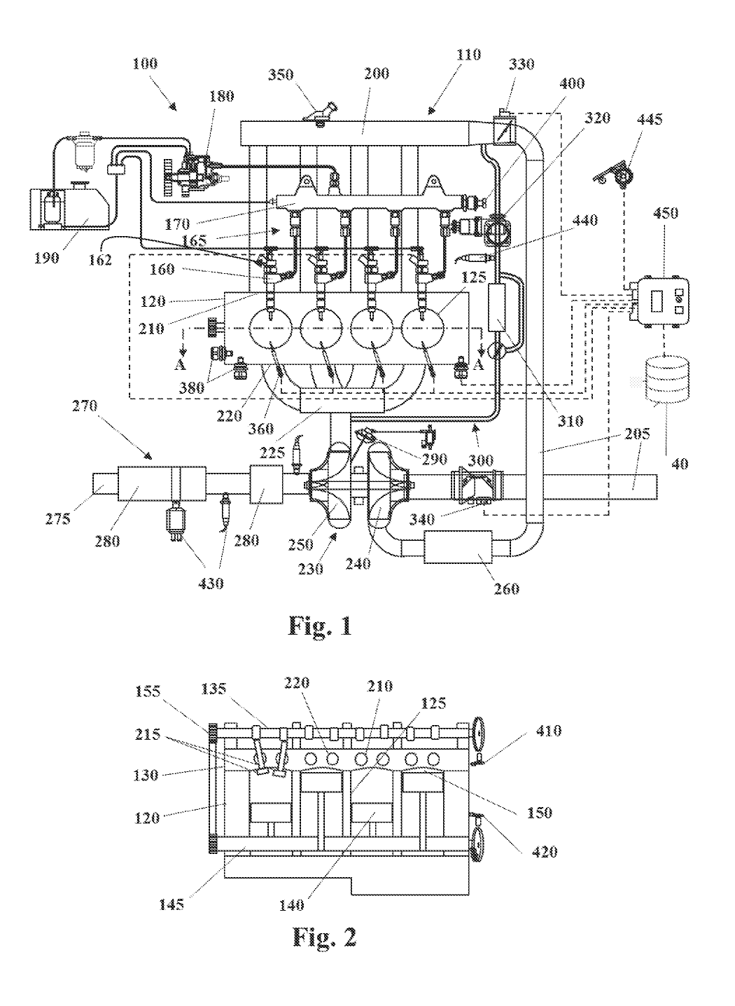

Some embodiments may include an automotive system 100, as shown in FIGS. 1 and 2, having an internal combustion engine (ICE) 110 with an engine block 120 defining at least one cylinder 125 and a piston 140 coupled to rotate a crankshaft 145. A cylinder head 130 cooperates with the piston 140 to define a combustion chamber 150.

A fuel and air mixture (not shown) into the combustion chamber 150 and ignited, resulting in hot expanding exhaust gasses causing reciprocal movement of the piston 140. The fuel is provided by at least one fuel injector 160 and the air through at least one intake port 210. The fuel is provided at high pressure to the fuel injector 160 from a fuel rail 170 in fluid communication with a high pressure fuel pump 180 that increase the pressure of the fuel received from a fuel source 190. The fuel injection system with the above disclosed components is known as Common Rail Diesel Injection System (CR System). The main advantage of this injection system, compared to others, is that due to the high pressure in the system and the electromagnetically controlled injectors it is possible to inject the correct amounts of fuel at exactly the right moment. This implies lower fuel consumption and fewer emissions.

Each of the cylinders 125 has at least two valves 215, actuated by a camshaft 135 rotating in time with the crankshaft 145. The valves 215 selectively allow air into the combustion chamber 150 from the port 210 and alternately allow exhaust gases to exit through a port 220. In some examples, a cam phaser 155 may selectively vary the timing between the camshaft 135 and the crankshaft 145.

The air may be distributed to the air intake port(s) 210 through an intake manifold 200. An air intake duct 205 may provide air from the ambient environment to the intake manifold 200. In other embodiments, a throttle body 330 may be provided to regulate the flow of air into the manifold 200. In still other embodiments, a forced air system such as a turbocharger 230, having a compressor 240 rotationally coupled to a turbine 250, may be provided. Rotation of the compressor 240 increases the pressure and temperature of the air in the duct 205 and manifold 200. An intercooler 260 disposed in the duct 205 may reduce the temperature of the air. The turbine 250 rotates by receiving exhaust gases from an exhaust manifold 225 that directs exhaust gases from the exhaust ports 220 and through a series of vanes prior to expansion through the turbine 250. The exhaust gases exit the turbine 250 and are directed into an exhaust system 270. This example shows a fixed geometry turbine 250 including a waste gate 290. In other embodiments, the turbocharger 230 may be a variable geometry turbine (VGT) with a VGT actuator arranged to move the vanes to alter the flow of the exhaust gases through the turbine.

The exhaust system 270 may include an exhaust pipe 275 having one or more exhaust aftertreatment devices 280. The aftertreatment devices may be any device configured to change the composition of the exhaust gases. Some examples of aftertreatment devices 280 include, but are not limited to, catalytic converters (two and three way), oxidation catalysts, lean NOx traps, hydrocarbon adsorbers, selective catalytic reduction (SCR) systems. Other embodiments may include an exhaust gas recirculation (EGR) system 300 coupled between the exhaust manifold 225 and the intake manifold 200. The EGR system 300 may include an EGR cooler 310 to reduce the temperature of the exhaust gases in the EGR system 300. An EGR valve 320 regulates a flow of exhaust gases in the EGR system 300.

The automotive system 100 may further include an electronic control unit (ECU) 450 in communication with one or more sensors and/or devices associated with the ICE 110 and equipped with a data carrier 40. The ECU 450 may receive input signals from various sensors configured to generate the signals in proportion to various physical parameters associated with the ICE 110. The sensors include, but are not limited to, a mass airflow, pressure, temperature sensor 340, a manifold pressure and temperature sensor 350, a combustion pressure sensor 360, coolant and oil temperature and level sensors 380, a fuel rail pressure sensor 400, a cam position sensor 410, a crank position sensor 420, exhaust pressure and temperature sensors 430, an EGR temperature sensor 440, and an accelerator pedal position sensor 445. Furthermore, the ECU 450 may generate output signals to various control devices that are arranged to control the operation of the ICE 110, including, but not limited to, the fuel injectors 160, the throttle body 330, the EGR Valve 320, the waste gate actuator 290, and the cam phaser 155. Note, dashed lines are used to indicate communication between the ECU 450 and the various sensors and devices, but some are omitted for clarity.

Turning now to the ECU 450, this apparatus may include a digital central processing unit (CPU) in communication with a memory system and an interface bus. The CPU is configured to execute instructions stored as a program in the memory system, and send and receive signals to/from the interface bus. The memory system may include various storage types including optical storage, magnetic storage, solid state storage, and other non-volatile memory. The interface bus may be configured to send, receive, and modulate analog and/or digital signals to/from the various sensors and control devices. The program may embody the methods disclosed herein, allowing the CPU to carryout out the steps of such methods and control the ICE 110.

The program stored in the memory system is transmitted from outside via a cable or in a wireless fashion. Outside the automotive system 100 it is normally visible as a computer program product, which is also called computer readable medium or machine readable medium in the art, and which should be understood to be a computer program code residing on a carrier, said carrier being transitory or non-transitory in nature with the consequence that the computer program product can be regarded to be transitory or non-transitory in nature.

An example of a transitory computer program product is a signal, e.g. an electromagnetic signal such as an optical signal, which is a transitory carrier for the computer program code. Carrying such computer program code can be achieved by modulating the signal by a conventional modulated technique such as QPSK for digital data, such that binary data representing said computer program code is impressed on the transitory electromagnetic signal. Such signals are e.g. made use of when transmitting computer program code in a wireless fashion via a Wifi connection to a laptop.

In case of a non-transitory computer program product the computer program code is embodied in a tangible storage medium. The storage medium is then the non-transitory carrier mentioned above, such that the computer program code is permanently or non-permanently stored in a retrievable way in or on this storage medium. The storage medium can be of conventional type known in computer technology such as a flash memory, an Asic, a CD or the like.

Instead of an ECU 450, the automotive system 100 may have a different type of processor to provide the electronic logic, e.g. an embedded controller, an onboard computer, or any processing module that might be deployed in the vehicle.

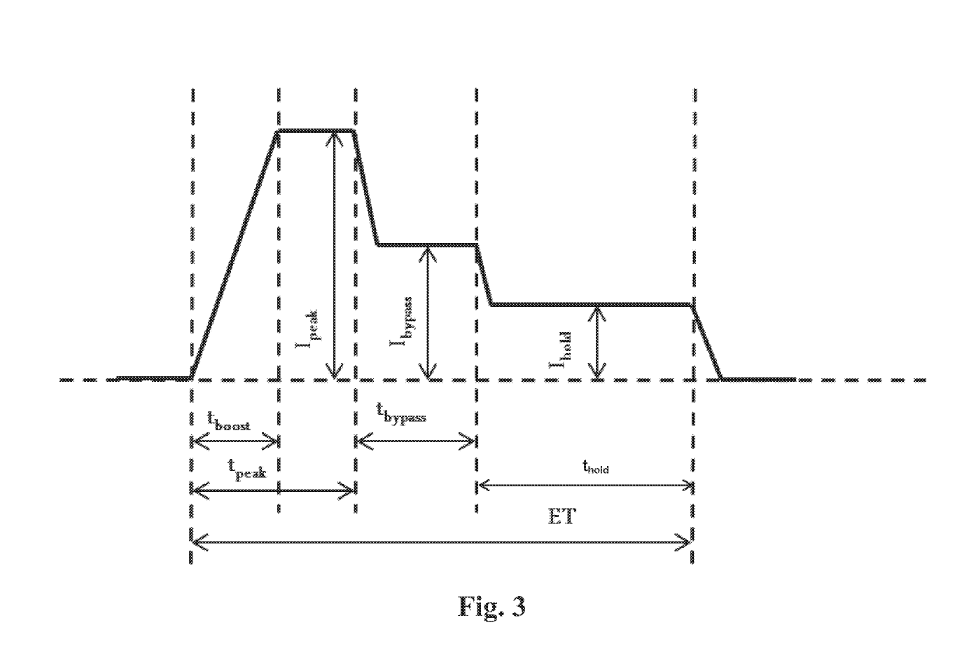

FIG. 3 illustrates a standard energizing electrical current profile, for example the one for a main injection. As known, the time between the electric opening command and the closing command is generally referred as energizing time ET of the fuel injector. The standard current profile includes a time interval t_{boost} during which the current reaches a remarkably high value, on the order of 10-20 A, the so called “peak” current Iₚₑₐₖ. Reason for this high current value is to accelerate as much as possible the injector opening. As soon as such conditions are satisfied, after a time interval tₚₑₐₖ, which is calculated from the opening command, the current value to guarantee the injector needle remains lifted is lower, on the order of less than 10 A. The lowering of the current value is performed in two steps. In a first step, for a time interval t_{bypass,} the current will assume an intermediate value I_{bypass}. Then in the second step, corresponding to a time interval t_{hold}, the standard current profile is characterized by a current hold value I_{hold} smaller than the peak current and the bypass current values.

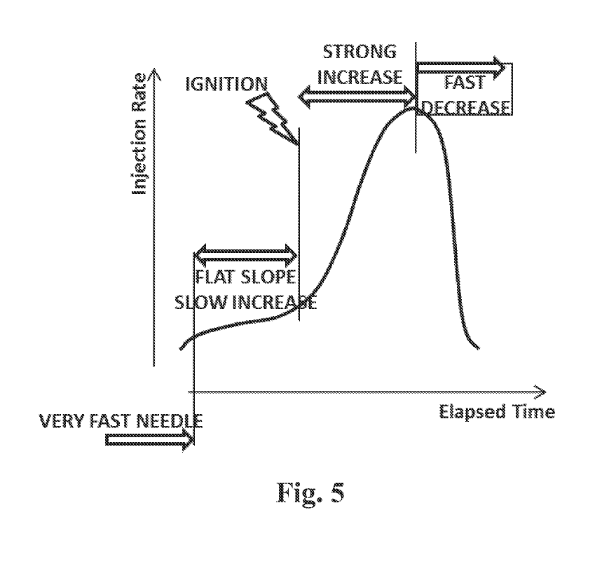

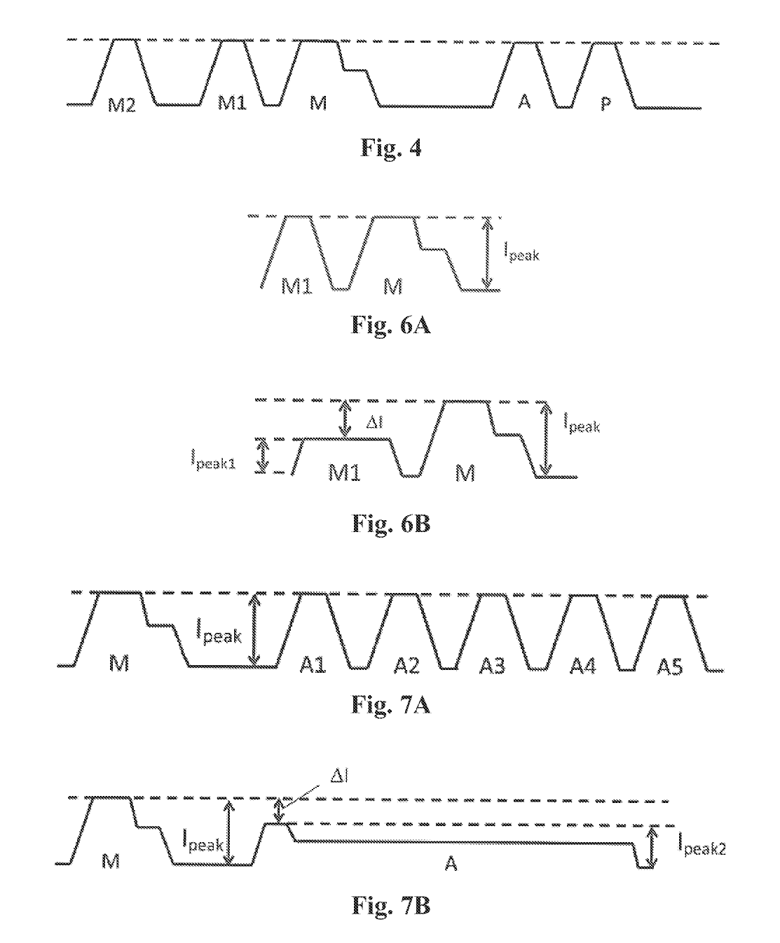

As known, according to the engine operating point, one or more fuel injections can be performed, each other separated in time. FIG. 4 shows a schematic fuel injection sequence, each injection represented by its corresponding energizing current profile. A main fuel injection M is normally performed in a time interval during which the position of the involved engine piston is around the top dead center. For different engine operating points, for instance in part load, one or more pilot injections M2 can precede main injection. Typically, an injection preceding and being very close to main injection is called boot injection M1. Further, mainly due to the regeneration processes of the exhaust gas aftertreatment system, also one or more after injections A (injections still contributing to the engine torque) or post injections P (late injections do not contributing to the engine torque formation, since the exhaust port is already open. and the related fuel combustion happens in the exhaust system, out of the cylinder) may follow main injection.

To improve the control of a fuel injector, also for injection requirements different from the standard one, for example during warm-up or during regeneration process of aftertreatment devices, a method, giving as output different injection current profiles for each pulse of the scheduled injection pattern, is proposed. The method has been developed to provide a higher flexibility in choosing injection, current profiles, in. a way to match, for every engine operating condition, the optimal injection requirements. The optimal injection requirements are illustrated in FIG. 5. For example, for an optimal shaping of the flow-rate of a fuel injector, such requirements are the followings. A fast injector needle opening to minimize the injection delay. A low injection rate in the first phase (flat slope, i.e. slow increase), corresponding to the ignition delay. In fact, for optimal engine combustion, a little amount of fuel is needed before the start of the combustion. Then, a strong increase of the injection rate is needed after the start of the combustion, until the maximum injection rate has been reached. This behavior satisfies the desired heat release behavior, required by an optimal combustion. Finally, a fast injection rate decrease at the end of injection and a high needle closing velocity are required, in order to stop fuel injection as soon as the combustion conditions for the fuel degrade (e.g. pressure reduction during the engine expansion phase).

FIGS. 6a and 6b show examples of a first application of preferred method, for example during a warm-up phase. In such conditions, a split of main injection in two pulses (pilot injection or boot injection and main injection) is convenient for an optimal combustion. The graph shows a comparison of a split main injection, realized with standard current profiles (FIG. 6a) or with variable current profiles, according to an embodiment of the present disclosure (FIG. 6b). In case a standard current profile is used, the two pulses M1, M can have the same peak current value Iₚₑₐₖ. On the other hand, by using variable current profiles, the first pulse M1 (the pilot injection or the boot injection) can have a peak current value Iₚₑₐₖ₁, which is smaller than the peak current value Iₚₑₐₖ of the main injection by an amount of ΔI. Using such different current profiles allows the injection rate to become more similar to the optimal behavior shown in FIG. 5.

In general, according to different aspects of the embodiment, the energizing current profile for a pilot injection or for a boot injection can have one or more of the following parameters not equal to the correspondent parameters of main injection: peak current (Iₚₑₐₖ≠Iₚₑₐₖ₁), bypass current (I_{bypass}≠I_{bypass1}), hold current (I_{hold}≠U_{hold1}), time interval of the peak current (tₚₑₐₖ≠tₚₑₐₖ₁) and time interval of the bypass current (t_{bypass}≠t_{bypass1}) where the suffix “1” is related to pilot injections M2 or boot injections M1, and where parameters without a suffix relate to the main injection.

FIGS. 7a and 7b show a second example of a practical application of the present method, in this case during a regeneration process of an aftertreatment device. In such conditions, a train or series of so-called after injections or post injections is performed. Their purpose is to warm the exhaust line, so that the regeneration process of aftertreatment devices (for example, a lean NOx trap or a particulate fitter) can property occur. The graph in FIG. 7 shows a main injection pulse M and a split after injection (in the example, five pulses A1, . . . , A5), which are performed with a standard current profile and have the same peak. current value Iₚₑₐₖ of main injection (FIG. 7a). On the other hand, by using variable current profiles (FIG. 7b), a single after injection A can be performed, with a peak current value Iₚₑₐₖ₂, which is smaller than the peak current value Iₚₑₐₖ of the main injection by an amount of ΔI. The effect of such different current profile for the after injection is to reduce the fuel flow rate and a very low injection flow rate allows better control of the oil dilution, at the same time maintaining low energy consumption.

In general, according to different aspects of this embodiment, the energizing current profile for an after injection or for a post injection can have one or more of the following parameters not equal to the correspondent parameters of main injection: peak current (Iₚₑₐₖ≠Iₚₑₐₖ₂), bypass current (I_{bypass}≠I_{bypass2}), hold current (I_{hold}≠I_{hold2}), time interval of the peak current (tₚₑₐₖ≠tₚₑₐₖ₂) and time interval of the bypass current (t_{bypass}≠t_{bypass2}), where the suffix “2” is related to after A or post P injections, and where parameters without a suffix relate to the main injection.

Therefore, all parameters of the current profiles (current values and time intervals, as shown in FIG. 3) can be controlled, by using the strategy of variable current profiles. In this way, both needle lift profile and injection flow rate can be modulated. In principle, by varying such control parameters, a full continuous modulation of the injection could be possible, pulse by pulse.

To make the implementation of the present strategy in the ECU easier, a limited number of current profiles can be defined, based on the injection strategy to be applied. For each defined current profile, each electrical pulse (pilot injection, main injection, after injection, post injection) is scheduled with its own current profile. A dedicated energizing time map for each current profile has to be calibrated for control of the injected quantities.

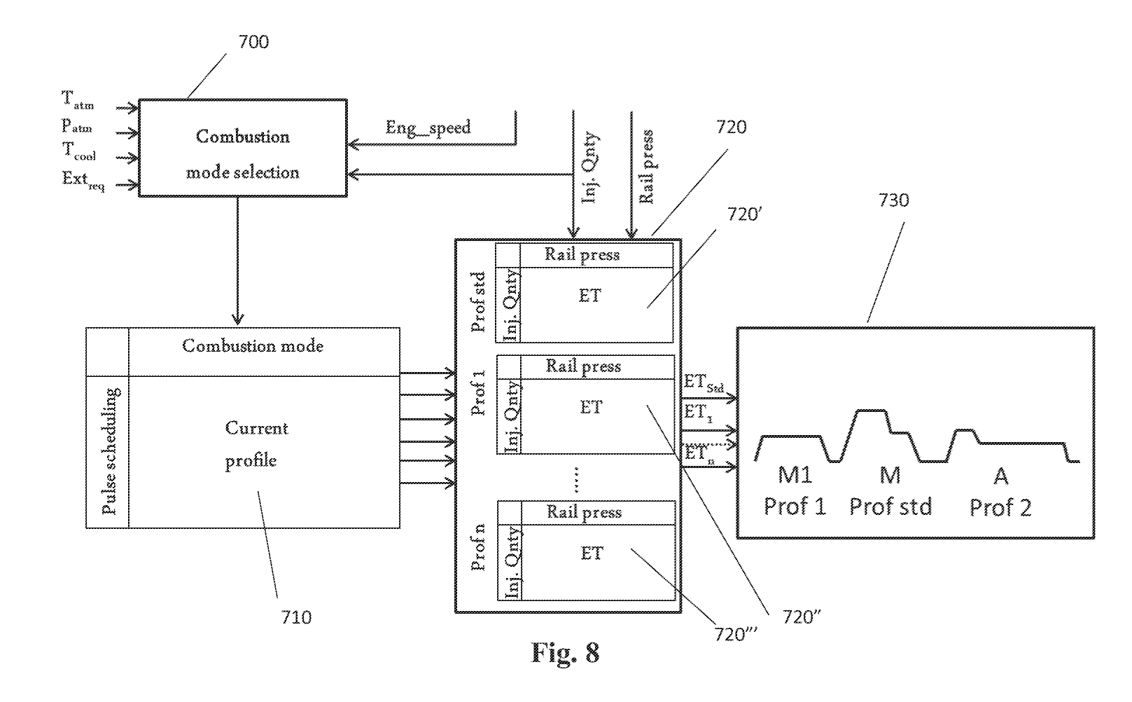

FIG. 8 is a high level block scheme of the present method. At first, a combustion mode is selected from a combustion mode block 700, by using the following input parameters: ambient conditions (pressure pₐₜₘ, temperature tₐₜₘ), engine conditions, particularly the coolant temperature (T_{cool}), external requests (Ext_{req}) (for example a DPF regeneration) and, of course, engine requests, namely, engine speed (Eng_speed) and engine load, i.e. injected quantity (Inj.Qnty).

After the combustion mode has been selected, a dedicated current profile block 710 is used. Such a map provides the selection of a specific current profile (e.g., the standard profile (Prof std) or other specific current profiles (Prof 1, Prof 2, Prof 3) based on the selected combustion mode (e.g., C1 combustion, C2 combustion, Rgn, IQF, MultiAfter) and on the selected injection pulses. The injection pulse scheduling can include one or more pilot injections or boot injections (PILOT1, PILOT2), a single or a split main injection (MAIN, MAIN1), an after injection (AFTER), a post injection (POST). For each scheduled injection pulse, the algorithm allows to select the specific current profile.

Then the energizing time block 720 is used. More precisely, this block include a set of maps 720′, 720″ . . . , 720′″, whose input are injected quantities and rail pressure and the output is the energizing time. Each of the maps is related to a specific current profile. The outcome of this block is the energizing time for each scheduled injection. This can be represented in an injection pattern block 730: each injection will have the desired quantity with the injection rate shape that best fits with the combustion requirement of the defined engine operating point. In the example the split main injection (M1) will get a first current profile (Prof1), main injection (M) will get a standard current profile (Prof std) and the after injection will get a second specific current profile (Prof 2).

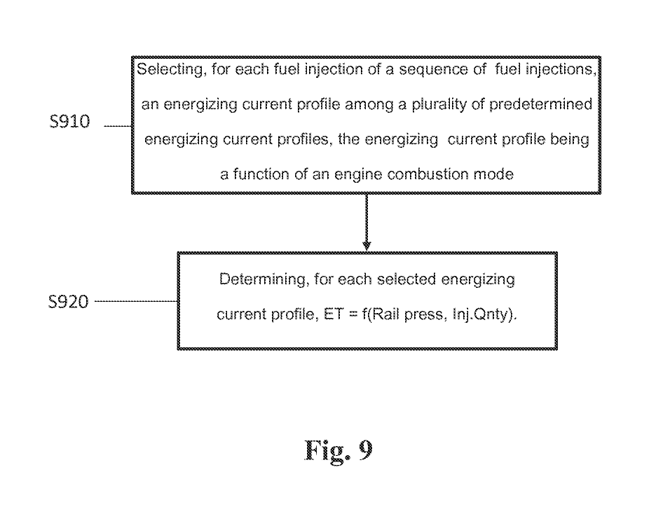

FIG. 9 represents a flowchart of the present method of operating a fuel injector 160 of an internal combustion engine 110. The method includes the step S910 of selecting, for each fuel injection of a sequence of fuel injections, an energizing current profile among a plurality of predetermined energizing current profiles, the energizing current profile being a function of an engine combustion mode, and the step S920 of determining, for each selected energizing current profile, a corresponding energizing time (ET) as a function of a common rail pressure value (Rail press) and a fuel quantity value (Inj.Qnty).

Summarizing the present method obtains remarkable benefits in terms of CO₂ reduction and emission improvement. In particular, by means of a better management of the injections, using variable current profiles, an improvement of combustion efficiency, warm-up behavior and aftertreatment strategies can be obtained.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-15. (canceled)

16. A method of operating a fuel injector of an internal combustion engine, the method comprising:
selecting an energizing current profile from a plurality of predetermined energizing current profiles based on an engine combustion mode;
determining a corresponding energizing time as a function of a common rail pressure value and a fuel quantity value; and
driving the fuel injector with the energizing current profile for the energizing time interval.

17. The method according to claim 16, wherein the method further comprises wherein the selected energizing current profile comprises a main injection and at least one secondary injection selected from the group including: a pilot injection, a boot injection, an after injection and a post injection, wherein the secondary injection has a peak current value which is less than a peak current value of the main injection.

18. The method according to claim 16, wherein the selected energizing current profile comprises a main injection and at least one secondary injection selected from the group including: a pilot injection, a boot injection, an after injection and a post injection, wherein the secondary injection has a bypass current value which is less than a bypass current value of the main injection.

19. The method according to claim 16, wherein the selected energizing current profile comprises a main injection and at least one secondary injection selected from the group including: a pilot injection, a boot injection, an after injection and a post injection, wherein the secondary injection has a hold current value which is less than a hold current value for the main injection.

20. The method according to claim 16, wherein the selected energizing current profile comprises a main injection and at least one secondary injection selected from the group including: a pilot injection, a boot injection, an after injection and a post injection, wherein the secondary injection has a time interval of the peak current which not equal to a time interval of the peak current for the main injection.

21. The method according to claim 16, wherein the selected energizing current profile comprises a main injection and at least one secondary injection selected from the group including: a pilot injection, a boot injection, an after injection and a post injection, wherein the secondary injection has a time interval of the bypass current which is not equal to a time interval of the bypass current for the main injection.

22. A method of operating a fuel injector of an internal combustion engine, the method comprising:
selecting an energizing current profile from a plurality of predetermined energizing current profiles based on an engine combustion mode, the selected energizing current profile defining a main injection having a set of main injection parameters including peak current value, a time interval of peak current, a bypass current value, a time interval of bypass current, and a hold current value, and at least one secondary injection having a set of secondary injection parameters including a peak current value, a time interval of peak current, a bypass current value, a time interval of bypass current, and a hold current value, wherein at least one of the set of secondary injection parameters is not equal to a corresponding one of the set of primary injection parameters;
determining a corresponding energizing time as a function of a common rail pressure value and a fuel quantity value; and
driving the fuel injector with the energizing current profile for the energizing time interval.

23. The method of claim 22 wherein the secondary injection comprises at least one of a pilot injection, a boot injection, an after injection and a post injection.

24. The method of claim 22 wherein the secondary peak current value is not equal to the main peak current value.

25. The method of claim 22 wherein the secondary bypass current value is not equal to the main bypass current value.

26. The method of claim 22 wherein the secondary hold current value is not equal to the main hold current value.

27. The method of claim 23 wherein the secondary time interval of the peak current which is not equal to the main time interval of the peak current.

28. The method of claim 22 wherein the secondary time interval the bypass current which is not equal to the main time interval of the bypass current.

29. A computer program comprising a non-transitory computer readable medium having a computer-code which when executed on a processor is configured to:
select an energizing current profile from a plurality of predetermined energizing current profiles based on an engine combustion mode;
determine a corresponding energizing time as a function of a common rail pressure value and a fuel quantity value; and
drive a fuel injector by the energizing current profile for the energizing time interval.

30. A control apparatus for an internal combustion engine, comprising an Electronic Control Unit, a data carrier associated to the Electronic Control Unit and a computer program according to claim 28 stored in the data carrier.
